(19) United States
(12) Patent Application Publication
(10) Pub. No.: US 2005/0072922 A1
(43) Pub. Date: Apr. 7, 2005

(54) Device for improving the visibility conditions in a motor vehicle

(76) Inventors: Joerg Moisel, Neu-Ulm (DE); Michael Holz, Senden (DE)

Correspondence Address: PENDORF & CUTLIFF, 5111 MEMORIAL HIGHWAY, TAMPA, FL, 33634-7356, US

(21) Appl. No.: 10/957,795

(22) Filed: Oct. 4, 2004

(30) Foreign Application Priority Data
Oct. 2, 2003 (DE) 103 46 483.2-31

(51) Int. Cl. G02F 1/01

(52) U.S. Cl. 250/330

(57) ABSTRACT

The invention relates to a device for improving the visibility conditions in a motor vehicle, having a radiation source for infrared radiation for irradiating the surroundings of the vehicle, having an infrared-sensitive camera for taking images of at least part of the irradiated surroundings, having a display unit for displaying collected image data, and having a control unit for controlling the device. In this context, the control unit is embodied in such a way that the display is switched off after a time period t which is selected as a function of the collected image data has expired. The camera is preferably selected in such a way that it is sensitive in the range of visible light. The time period t is preferably selected as a function of the brightness values and/or the contrast values of the collected image data. This device ensures very reliable operation for the user.

### BACKGROUND OF THE INVENTION

1. Field of Invention

The invention relates to a device for improving the visibility in a motor vehicle.

2. Related Art of the Invention

DE 40 32 927 C2 discloses a device for improving the visibility in a motor vehicle having a radiation source for infrared radiation for irradiating the surroundings of the vehicle, and having an infrared-sensitive camera which takes images of the irradiated field of vision of the driver and makes available the collected image data to the driver by means of a display device which is embodied as a head-up display and in which the image data is visually superimposed as a virtual image on the external landscape. By means of this device, the driver can see considerably better at night or under bad weather conditions, in particular when he is dazzled by oncoming vehicles. As a result of the use of infrared radiation, the driver is, in contrast, not dazzled by the oncoming traffic. Such devices of this type are called night vision systems.

By virtue of the improved visibility, the vehicle driver may be induced to look exclusively at the display and not to observe the direct surroundings any more, which can lead to misinterpretations. In particular there is the risk of the field of vision being overestimated and of driving too quickly owing to the supposedly better visibility.

### SUMMARY OF THE INVENTION

The invention is based on the object of specifying a device for improving the visibility conditions in a motor vehicle which reduces these disadvantages and as a result improves traffic safety.

This object is achieved by means of a device for improving the visibility conditions in a motor vehicle having the features of claim 1.

Advantageous developments of the device are the subject matter of the subclaims.

The device according to the invention for improving the visibility conditions in a motor vehicle is provided here with a control unit which is embodied in such a way that the display is switched off after a time period t which is selected as a function of the collected image data has expired. The collected image data is evaluated here with respect to its properties, for example the brightness values or contrast values by means of an image data evaluation unit, and the time period t is then selected as a function of these properties by means of the control unit. This selection is made either by means of a reference table in which a measure of the respective properties is related to a measure for the time period t or by means of a mathematical relationship, for example by means of a direct conversion rule which calculates a specific time period t, for example on the basis of the average brightness or the average contrast. For example, the frequency spectrum of the image data can be determined using a Fourier transformation and information about the field of vision can be derived therefrom. The time period t is then determined using this information about the field of vision. By selecting the time period it is possible to ensure a very current behavior of the device or control behavior which is matched to the current image data and thus to the current ambient situation. This ensures that the appropriate time period t is selected as a function of the respective ambient situation and thus the respective visibility conditions, and the vehicle driver is thus reliably induced to no longer rely too much on the displaying of the image data on the display. As a result it is possible to prevent the driver from taking into account only the image data displayed on the display, and to induce him at least to take into account further the direct surroundings. This leads to a marked improvement in the driving behavior and thus in the safety of the vehicle driver, of the vehicle, and also of the traffic as a whole.

It has also proven effective to evaluate the collected image data with respect to its displayed content by means of an image data evaluation unit by classifying a sensed traffic scene by means of a classifier. If, for example, the classifier assesses the course of the road as being a bendy section of road or as being a freeway, or assesses a road sign at the side of the road as being a road sign which relates to velocity, a time period t is selected in accordance with this assessment. This selection is typically made by means of a reference table. In a section of road with a large number of bends, a shorter time period t is selected than in the case of a straight course or in the case of a freeway. A longer time period t is also selected as the maximum velocity increases.

Furthermore, it is possible, since the mode of operation of the device forces the driver to stop looking at the representation of the surroundings on the display, to reduce the risk of tending to overestimate the visibility conditions and thus the risk of driving too fast since the vehicle driver cannot rely only on the improved visibility which is provided by the device according to the invention. Overall, these aspects lead to an improvement in the safety of the vehicle driver or the driver and thus also of the traffic as a whole and the persons involved in it.

The time period t is preferably selected in the range of less than one minute, in particular in a range between 2 and 30 seconds. It has also proven effective to select a time period t which is longer than a minute or in the region of several minutes. These time periods ensure that the vehicle driver is provided with sufficient reliable information by the device according to the invention which permits improved visibility at night or in bad weather. This improved visibility reduces the risk of accidents, the selective termination of the representation of image data on the display ensuring that the negative effects of this improved representation of the surroundings on the basis of the infrared radiation which is reflected by the surroundings and which is sensed via the infrared-sensitive camera and represented on the display do not occur, or occur only to a limited degree.

It has proven particularly effective to provide the user with the possibility of influencing in particular the maximum time period t so that this can then be used as a basis for switching off the representation on the display. This device proves very flexible and very user-friendly. Nevertheless it has proven effective not to give the vehicle driver complete control over the predefined time period t so that he does not select a maximum time period t which is too long as a result of which the positive inventive effect is dramatically restricted. Furthermore, it has proven particularly effective to change the time period t in accordance with the situation, as a function of the collected image data. For example, it has proven effective in the case of very bendy sections of road or stretches of road with a layout which is unfavorable for visibility to select a short time period t, which is done by the control unit. This device ensures that a very effective time period t is selected, which ensures a considerable increase in safety depending on the situation.

According to one preferred embodiment of the device, the control unit is embodied in such a way that, in addition to the display, the camera can be switched off. Here, the camera is switched off after a predefined time period t_{K}. The time period t_{K} can be of equal length to the time period t or longer than it. This ensures that the device operates very efficiently and reliably without the operational capability of the device being restricted. Making a selection of the time period t_{K} which is only slightly longer than the time period t ensures that the camera is not switched off before the display and that in addition the camera, as a large energy consumer which can only be re-activated very slowly, is not switched off too early with the display or directly after it and thus only much later. Alternatively or additionally to the camera, the radiation source is also switched on and off under the control of the control unit. In this case, the control unit ensures that the time period t and the time period t_{K} begin to run starting from the same switch-on time.

According to another preferred embodiment of the invention, in addition to the on and off switch for the device, an additional switch is provided for switching on the display and/or the camera. This additional switch permits the active, conscious switching on of the representation of images on the display after the display or the camera has been switched off after the time periods t and t_{K} have expired. This ensures that the vehicle driver can completely activate the device as required by activating the additional switch, and can thus obtain the advantage of improved visibility. It has proven particularly effective here to implement the additional switch in the region of the steering wheel, in particular in the form of the headlamp flasher switch or a rocker on the steering wheel. The arrangement of the additional switch in the region of the steering wheel makes it possible to activate the switch without the driver having to completely take one or both hands off the steering wheel. This leads to very safe handling of the device and thus to an increase in road safety. The use of the headlamp flasher switch as an additional switch for the device has proven particularly effective, ensuring that, by activating the headlamp flasher switch, not only the headlamp flashing function but also the display and the camera are re-activated. This leads to a situation in which the surroundings of the vehicle which are irradiated by the infrared radiation source are at least partially sensed by the camera and the collected image data can be displayed on the display. When switching on occurs, the time which has passed since the switching on is determined in the control unit in order to compare this time with the time period t or t_{K} in order then to switch off the display, the radiation source or the camera when these time periods are reached.

It has also proven particularly effective to restrict the representation of the collected image data by the display essentially to the time period when a switch is activated, and accordingly to select a very short time period t, in an extreme case equal to 0 seconds. This ensures that a vehicle driver makes use of the device according to the invention only when required, for example when dazzled by oncoming traffic at night, and otherwise concentrates on sensing the direct surroundings, which significantly reduces the risk of overestimating a situation.

It has proven particularly advantageous to make the switching off of the display, that is to say the termination of the representation of images, sudden, that is to say abrupt. This has the advantage that a very simple control of the device, which is not very susceptible to faults, is sufficient to obtain this positive effect according to the invention for increasing road safety.

Furthermore, according to another embodiment of the invention it has proven effective to make the switching-off process gradual so that the reproduction of images does not change abruptly but rather gradually, over a certain time period, from the complete representation of image data to the switched-off state without representation of images. In this context, this gradual switching off can be brought about, in particular, by restricting the brightness values or contrast values of the representation of images or of the display in such a way that an increasingly low brightness range or contrast range is continuously made available. This reduction of the brightness range or contrast range is continued until these ranges have dropped to zero and thus the display is switched off. Alternatively, it has also proven effective for this purpose to disassociate the image data by means of artificial noise and to make the disassociation become stronger and stronger, which is brought about by increasing the proportion of noise until the image data can virtually no longer be perceived. This state corresponds to the switched-off display since this display is no longer suitable for displaying the image data to be displayed which relates to the sensed surroundings which are irradiated by infrared light. This switching-off process is preferably implemented as a linearly extending gradual transition, which is made possible by means of a control which is not too complicated. Alternatively, nonlinear courses are also conceivable. This embodiment of the device according to the invention with a gradual switching-off process ensures that the user receives information about the imminent final termination of the representation of images before the final switching off of the representation of images on the display, and is thus not unpleasantly surprised. This has a positive effect on the reduction of the risk of accidents.

It has also proven particularly effective to signal the switching off to the vehicle driver before the switching off is carried out. This signaling is carried out, for example, by means of a visual representation on the display, alternatively or additionally by means of haptic signaling, for example by vibrating the steering wheel or by means of an audible signal, for example by the sounding of a short tone. This advance information before the switching off is carried out ensures that the vehicle driver is forewarned to a particular degree before the switching off is carried out. This leads to an improvement in road safety. Audible warning signals have proven particularly effective since they can also be perceived without visual contact with the display, for example during the direct consideration of the surroundings of the vehicle, and can thus be perceived by the vehicle driver at regular intervals without interruptions or with only short interruptions in such a way that he is not surprised by the switching off of the display or the representation of images on the display.

It has proven effective to represent the residual running time on the display as a particularly preferred way of signaling the imminent switching off so that the vehicle driver is always informed about the remaining time until the camera or the display is switched off. This representation is preferably made in seconds or else in the form of a bar diagram. In particular the bar representation proves a very intuitive form of representation which is easy to comprehend and which is sufficiently reliable in providing the vehicle driver with a forewarning while simultaneously not distracting him very much. This form of representation of the signaling in the form of the residual running time, in particular in the form of the bar representation, provides a very reliable and informative warning about the switching off of the representation on the display, which leads to very reliable operation of the device and thus to a considerable increase in road safety.

According to one particularly preferred embodiment of the device, the control unit is embodied in such a way that the current vehicle velocity can be fed to it and it controls the switching off in such a way that the display or the camera is switched off when the vehicle velocity V exceeds a predefined maximum velocity. In this case, it is ensured that the vehicle driver cannot rely on the subjective impression of particularly good, overestimated visibility and correspondingly selects his vehicle velocity V inappropriately high in accordance with his misinterpreted field of vision. As a result of the velocity-dependent switching off when a maximum velocity Vₘₐₓ is exceeded, it is ensured that the vehicle driver is forced to rely on the direct sensing of the surroundings of the vehicle, i.e. for example to rely on the usual sensing of the surroundings of the vehicle at night or when visibility is poor, and that he cannot use the improved visibility by means of the device which can be made available to him via the display. As a result of this switching off he is thus forced to consider his velocity at regular intervals since the improved visibility is now no longer available to him and correspondingly he must select his driving velocity in accordance with the actual visibility in the visible range, that is to say without support by infrared radiation, and correspondingly must make a reduced selection. This leads to a situation in which the driver then reduces his driving velocity at regular intervals on the basis of the poorer visibility, which leads to a situation in which the device can be fully re-activated when the velocity drops below a corresponding velocity limit and the improved visibility of the surroundings of the vehicle which is acquired by means of the device can be made available to the driver.

### BRIEF DESCRIPTION OF THE DRAWING

The invention will be explained below with reference to an exemplary implementation of the device according to the invention for improving the visibility conditions in a motor vehicle. The invention is not restricted to this embodiment.

FIG. 1 shows a schematic design of the device according to the invention for improving the visibility conditions in a motor vehicle.

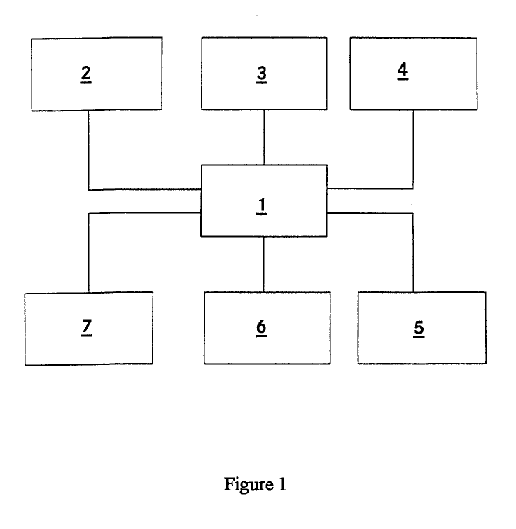

### DETAILED DESCRIPTION OF THE INVENTION

This device exhibits a radiation source 2 for infrared radiation which irradiates infrared radiation with a wavelength of approximately 800 nm. The radiation source 2 is implemented as an infrared laser. This radiation source 2 is arranged in the front region of the vehicle in the region of the headlights and illuminates the region in front of the vehicle. In addition, this device has an infrared-sensitive camera 3 which is arranged in the vehicle and is orientated in such a way that it senses at least part of the surroundings which are irradiated by the infrared radiation source 2, and feeds the collected image data to the display 4 via the control unit 1. By means of the display 4, the image data which is fed to it and collected by the camera 3 is displayed and thus made available to a vehicle driver. The control unit 1 controls the infrared radiation source 2, the camera 3 and the display 4 in this context.

The infrared radiation source 2 radiates infrared radiation here, which is reflected at least partially from the surroundings and collected by the infrared-sensitive camera 3 as reflected radiation and converted into image data. This image data is represented by the display 4 either directly or after a certain degree of image signal processing by means of the image evaluation unit 6. As a result, the image which is represented on the display 4 is an infrared representation of the surroundings of the vehicle. Since the infrared reflective properties and radiation properties of the surroundings differ from the properties in the visible light range, the image represented will also differ from the direct view of the surroundings by the vehicle driver. By using the device it is possible to use these differences advantageously, which leads to improved visibility in particular at night, but also in bad weather conditions such as in the rain or in fog.

The control unit 1 controls the display 4 here in such a way that after a predefined time period t has expired the representation of images on the display 4 is terminated and the display 4 is thus switched off. Here, for the predefined time period t, the collected image data is evaluated with respect to its properties and at the same time with respect to the brightness values and contrast values by means of an image evaluation unit 6, and the time period t is then selected as a function of these properties. This selection is made either by means of a reference table in which a measure of the respective properties is related to a measure of the time period t. As a result of this selection of the time period it is possible to ensure a very up-to-date behavior of the device or control behavior which is tailored to the current image data and thus to the current situation of the surroundings. This ensures that the appropriate time period t is selected as a function of the respective situation of the surroundings and thus the respective visibility conditions.

It is not necessary to completely switch off the display 4, for the operational capability of the device according to the invention it is sufficient to merely terminate the representation of images. The switching off of the display 4 requires the vehicle driver to look away from the display 4 and to direct his gaze directly onto the surroundings of the vehicle again. This ensures that he cannot be dazzled by the improved visibility which is provided by the device according to the invention and, owing to the improved visibility, misinterpret his own capabilities, the vehicle or the external circumstances and, for example, drive too quickly or with an inappropriate velocity. Instead, the switching off of the display 4 causes him to turn his attention directly to the surroundings of the vehicle and to adapt his driving behavior in an orderly manner to the visibility conditions which are then available to him and to use again the improved visibility after the device or the representation of images of the display 4 has been switched on again, without automatically being subject to a misinterpretation of the situation. This effect has proven very advantageous and very acceptable. In addition to the switching off of the display 4 after a time period t, the control unit 1 also has the control function of switching off the camera 3 after a time period t_{K} which is one minute longer than the time period t, which is in the region of one minute or half a minute. This additional control function ensures very effective operation of the device, in which case, on the one hand, the operational capability of the device is maintained without restriction but, on the other hand, the consumption of energy of the device is markedly reduced. The consumption of energy of such a device is of particular significance in a vehicle since such a vehicle has a large number of electronic components of which a large number operate simultaneously and correspondingly consume a considerable amount of energy which the vehicle, with its autonomous energy supply, can make available only to a limited degree.

Furthermore, the control unit 1 is connected to the headlamp flasher switch 5 which is arranged as an additional switch in the region of the steering wheel. The actuation of the headlamp flasher switch causes the display 4 or the camera 3 to be activated again and switched on again under the control of the control unit 1. As a result, the timing process is restarted and the display 4 or the camera 3 is kept operational until the time periods t and t_{K} have passed and the display 4 or the camera 3 is switched off as a function thereof. As a result of this simple embodiment of an additional switch for switching on the display 4 or the camera 3, a very robust and safe and easy-to-handle device is provided which, on the one hand, makes available improved visibility for the vehicle driver, and, on the other hand, prevents undesired driving only in accordance with the display, and, on the other hand, permits actuation without significant difficulties. By using the headlamp flasher switch 5 it is possible for the driver to activate the display 4 or the camera 3 by actuating the headlamp flasher switch in parallel, without the driver having to release the steering wheel from his secure grip. This leads to very safe handling of the device and thus to an increase in road safety.

The control unit 1 is connected to an image evaluation unit 6 which carries out the termination of the representation of images, and thus the switching off of the display 4, in a gradual fashion. In this context, the collected image data is artificially degraded during the gradual switching off by adding noise components until only noise is represented on the display 4, and the display 4 can thus be switched off, as it were. As the noise increases, the image information which can be sensed, and thus the represented image data, becomes less useful for the vehicle driver, who is accordingly increasingly inclined to view and sense the surroundings of the vehicle directly. This gradual switching off ensures that the vehicle driver is forewarned of the imminent final switching off and is therefore not surprised by the final switching off. This has proven very positive for the vehicle driver.

Furthermore, a sensing unit 7 is provided which senses the vehicle velocity V and feeds it to the control unit 1. This control unit 1 compares the current vehicle velocity V, which has been sensed by the sensing unit 7, with a predefined maximum velocity Vₘₐₓ. If the current vehicle velocity V exceeds the maximum velocity Vₘₐₓ, the control unit 1 will switch off the display 4 in a corresponding way to the sequence of the time period t. In addition, the camera 3 is also switched off. When the velocity drops below the maximum velocity, the switched-off components are then activated again so that the image data which is collected by the camera 3 can be made available to the user again on the display 4.

The described device thus exhibits switching off of individual components 3, 4 as a function of the velocity V at which the vehicle is traveling or as a function of the operating time of the display 4 or of the camera 3. This embodiment of the device makes it possible to limit incorrect preconceptions of the vehicle driver with respect to the driving situation and thus to increase the road safety for the vehicle driver, the vehicle and the traffic as a whole.

1. A device for improving the visibility conditions in a motor vehicle, having
a radiation source for infrared radiation for irradiating the surroundings of the vehicle,
an infrared-sensitive camera for taking images of at least part of the irradiated surroundings,
a display unit for displaying collected image data, and
a control unit for controlling the device,
wherein the control unit is embodied in such a way that the display is switched off after expiration of a time period t which is selected as a function of the collected image data.

2. The device for improving the visibility conditions in a motor vehicle as claimed in claim 1, wherein the camera is sensitive in the range of visible light and the time period t is selected as a function of the brightness values of the collected image data.

3. The device for improving the visibility conditions in a motor vehicle as claimed in claim 1, wherein the time period t is selected as a function of the contrast values of the collected image data.

4. The device for improving the visibility conditions in a motor vehicle as claimed in claim 1, wherein the control unit is embodied in such a way that, in addition to the display, the camera and/or the radiation source can be switched off after a predefined time period t_{K}.

5. The device for improving the visibility conditions in a motor vehicle as claimed in claim 1, in addition to an on/off switch for the device, an additional switch is provided for switching on the display after switching off occurs.

6. The device for improving the visibility conditions in a motor vehicle as claimed in claim 5, wherein the additional switch is implemented in the region of the steering wheel, in particular by means of a headlamp flasher switch or a steering wheel rocker.

7. The device for improving the visibility conditions in a motor vehicle as claimed in claim 1, wherein the display is switched off suddenly.

8. The device for improving the visibility conditions in a motor vehicle as claimed in claim 1, wherein the switching off of the display is gradual.

9. The device for improving the visibility conditions in a motor vehicle as claimed in claim 1, wherein the control unit is embodied in such a way that before the switching off takes place it causes the switching off to be signalled.

10. The device for improving the visibility conditions in a motor vehicle as claimed in claim 9, wherein a residual running time display is provided for the purpose of signaling.

11. The device for improving the visibility conditions in a motor vehicle as claimed in claim 1, wherein the time period t lies, and in particular can be set, in the minute range, in particular in the range of half a minute.

12. The device for improving the visibility conditions in a motor vehicle as claimed in claim 1, wherein the control unit is embodied in such a way that switching off occurs when a vehicle velocity V above a predefined maximum velocity Vₘₐₓ is exceeded.
